(19) United States
(12) Patent Application Publication
(10) Pub. No.: US 2016/0019588 A1
(43) Pub. Date: Jan. 21, 2016

(54) System and Method for Displaying Search Results

(71) Applicant: Zakly Inc., Toronto (CA)

(72) Inventors: Shane L. Wagg, Toronto (CA); Douglas W. Gebhardt, Toronto (CA); Brian R. Turner, Toronto (CA); Greg Geralde, Toronto (CA)

(21) Appl. No.: 14/729,337

(22) Filed: Jun. 3, 2015

(30) Foreign Application Priority Data
Jun. 6, 2014 (CA) 2854033

(51) Int. Cl. G06Q 30/02

(52) U.S. Cl. CPC G06Q 30/0256

(57) ABSTRACT

A computer implemented method of presenting search results, the method comprising the steps of receiving a search query from a client; using the search query, searching a first database of pay-per-click display items to generate a set of pay-per-click search results that match the search query; using the search query, searching a second database of cost-per-impression display items to generate a set of cost-per-impression search results that match the search query; sending returned pay-per-click search results, comprising at least a subset of the set of pay-per-click search results, if any, and returned cost-per-impression search results, comprising at least a subset of the set of cost-per-impression search results, if any, to the client.

### BACKGROUND OF THE INVENTION

1. Field of the Invention

This invention is directed to the field of computerized search, and in particular to internet and other database searching.

2. Description of Related Art

Many advertisers undertake advertising and marketing activities on the internet. The percentage of advertising dollars spent on internet advertising and marketing continues to grow.

An important component of internet advertising and marketing is search advertising and marketing. Internet advertisers leverage search engine technology to cause their advertising to reach its target. Thus, advertisers take steps to maximize the probability that their advertisements are seen by users of search engines (e.g. Google®, Bing®, Yahoo!®, Facebook®), who are likely to be interested in such advertisements. In other words, they target users who use search terms that would indicate a likely interest in such advertisements. So, for example, a Minneapolis shoe store would want its online advertising to be seen by persons in or near Minneapolis who use an internet search engine to search the term “shoes.” The higher up an advertiser's listing is on the search engine results page (SERF), the more likely it is to be seen. The listed items on the SERP typically comprise uniform resource locators (URLs), in the form of hypertext links to documents.

The two main components of search results are paid (also known as sponsored) listings or results, and organic listings or results. Organic and local search results are the results that are created “naturally” by the operation of the search engine's technology on the search term entered. An advertiser may, as part of its online marketing efforts, associate with its website appropriate keywords that will improve its position within organic search results when certain search terms are entered.

By contrast, paid results or paid listings are listings paid for by advertisers. Advertisers pay the operators of search engines to have links to the advertisers' websites listed in response to various search terms. Search engine technology is typically configured to display links identified as paid at a higher position than organic search results, and to order the paid links themselves according to various criteria, including the amount bid for each listing. Typically, paid listings visually start from a higher position than organic search results.

There are a number of problems with the system by which search results are returned and displayed. One is that in the overwhelming majority of cases (known estimates vary from 75 to 94 percent), search engine users click on organic search results but not paid ones. In short, users largely ignore paid search results. Thus, according to these figures, the estimated probability is no greater than 25% that any paid result at all will be clicked. If there is more than one paid listing, the probability of any particular one being clicked is even lower.

A second problem with the system by which search results are returned and displayed is that advertisers pay to be included among paid search results on a pay-per-click basis (PPC; also known as cost-per-click—CPC). Under a PPC model, no money is paid by the advertiser unless the advertiser's listing is clicked. If it is, the advertiser pays the advertising cost, which could be fixed, or set by auction, or determined some other way.

Paid search revenue thus relies on users clicking the advertisers' listings. To increase revenue, search engines have been appropriating progressively more screen space “above the fold” (i.e. in the part of the SERP visible without the user scrolling down) for paid search and proprietary search results, and pushing organic search results downward. The vast majority of search engine users are not interested in the paid listings, but only the organic ones. As more space gets used for paid and proprietary listings, users need to work harder to get down to the organic listings that they really want, and will see fewer organic listings on the first page of the SERP.

U.S. Pat. No. 7,437,353 (Marmaros et al.) describes a method for the unification of search results. A search engine executing on a client device receives a search query. The search engine executes the search on a local index and receives a first results set. The search query is also executed against a global index, generating a second results set. The search engine then combines the results sets to create a combined result set. The search engine causes the combined result set to be displayed or otherwise outputted to a user.

U.S. Pat. No. 8,359,300 (Shin) discloses a method of presenting search results. The method includes sending a search query to a server, wherein the search query does not include any geographical location identifier. A set of search results is received. The search results include first results and second results. The first results match the search query. Each first result corresponds to one or more locations associated with a respective geographic location and include links to additional information about the one or more locations. The method associates the respective geographic location with a client or user of the client. The second results correspond to internet accessible documents that satisfy the search query and include links to the internet accessible documents that satisfy the search query. The method includes presenting the first and second results in a single web browser window. Thus, this method is generally directed to delivering ordinary organic search results, and search results of local interest to the initiator of the search.

US published patent application no. 2010/0125506 discloses a particular type of generalized second price auction for sponsored search results. A search engine includes a query processor and a sponsored search auction. The query processor receives a query and determines multiple different reserve prices corresponding to the same number of advertisement slots of a search results page. It also determines a plurality of bid prices for each slot. Thus, rather than all bidders bidding for all slots at the same time, there are different reserve prices for each slot.

None of these references addresses the aforementioned problems with sponsored or paid search as it is currently executed.

### SUMMARY OF THE INVENTION

Therefore, what is desired is a search engine results delivery system that increases revenue possibilities for search engine operators, while preferably providing more useful and compelling advertising to search engine users.

Therefore, according to one aspect of the invention, there is provided a computer implemented method of presenting search results, the method comprising:

on a server system having a network search engine which comprises one or more processors, and memory storing one or more programs executed by the one or more processors:

receiving a search query from a client computer;

using the search query, searching a first database of pay-per-click display items to generate a set of pay-per-click search results that match the search query;

using the search query, searching a second database of cost-per-impression (CPI) display items to generate a set of cost-per-impression search results that match the search query; and

sending returned pay-per-click search results, comprising at least a subset of the set of pay-per-click search results, if any, and returned cost-per-impression search results, comprising at least a subset of the set of cost-per-impression search results, if any, to the client computer.

According to another aspect of the present invention, there is provided a computer implemented method of presenting search results, the method comprising:

on a client system having a search engine interface for entering search queries to a search engine associated with a server system in data communication with the client system:

sending a search query to the search engine;

receiving from the search engine a set of returned pay-per-click search results that match the search query, the set of returned pay-per-click search results generated by the search engine in response to the query;

receiving from the search engine a set of returned cost-per-impression search results that match the search query, the set of returned cost-per-impression search results generated by the search engine in response to the query; and

displaying or causing the display, at or within the client system, of at least a portion of the returned pay-per-click search results, and at least a portion of the returned cost-per-impression search results, in a single web browser window.

In a further aspect of the present invention, there is provided:

A) a computer-implemented method of presenting search results, the method comprising:
receiving a search query from a client computer;
using the search query, searching a first database of pay-per-click display items to generate a set of pay-per-click search results that match the search query;
using the search query, searching a second database of cost-per-impression display items to generate a set of cost-per-impression search results that match the search query; and
sending returned pay-per-click search results, comprising at least a subset of the set of pay-per-click search results, if any, and returned cost-per-impression search results, comprising at least a subset of the set of cost-per-impression search results, if any, to the client computer;

B) a system comprising at least one computer having at least one processor and at least one non-transitory computer-readable medium containing program instructions, which, when executed by the at least one processor of the at least one computer, cause the at least one processor to:
receive a search query from a client computer;
using the search query, search a first database of pay-per-click display items to generate a set of pay-per-click search results that match the search query;
using the search query, search a second database of cost-per-impression display items to generate a set of cost-per-impression search results that match the search query; and
send returned pay-per-click search results, comprising at least a subset of the set of pay-per-click search results, if any, and returned cost-per-impression search results, comprising at least a subset of the set of cost-per-impression search results, if any, to the client computer;

C) a computer program product comprising at least one non-transitory computer-readable medium containing program instructions, which, when executed by at least one processor of at least one computer, cause the at least one processor to:
receive a search query from a client computer;
using the search query, search a first database of pay-per-click display items to generate a set of pay-per-click search results that match the search query;
using the search query, search a second database of cost-per-impression display items to generate a set of cost-per-impression search results that match the search query; and
send returned pay-per-click search results, comprising at least a subset of the set of pay-per-click search results, if any, and returned cost-per-impression search results, comprising at least a subset of the set of cost-per-impression search results, if any, to the client computer;

D) a computer-implemented method of presenting search results, the method comprising:
sending a search query to a search engine associated with a server system in data communication with a client system having a search engine interface;
receiving, from the search engine, a set of returned pay-per-click search results that match the search query, the set of returned pay-per-click search results generated by the search engine in response to the query;
receiving, from the search engine, a set of returned cost-per-impression search results that match the search query, the set of returned cost-per-impression search results generated by the search engine in response to the query; and
displaying or causing the display, at or within the client system, of at least a portion of the returned pay-per-click search results, and at least a portion of the returned cost-per-impression search results, in a single web browser window;

E) a system comprising at least one computer having at least one processor and at least one non-transitory computer-readable medium containing program instructions, which, when executed by the at least one processor of the at least one computer, cause the at least one processor to:
send a search query to a search engine associated with a server system in data communication with a client system having a search engine interface;
receive, from the search engine, a set of returned pay-per-click search results that match the search query, the set of returned pay-per-click search results generated by the search engine in response to the query;
receive, from the search engine, a set of returned cost-per-impression search results that match the search query, the set of returned cost-per-impression search results generated by the search engine in response to the query; and
display or cause the display, at or within the client system, of at least a portion of the returned pay-per-click search results, and at least a portion of the returned cost-per-impression search results, in a single web browser window;

F) a computer program product comprising at least one non-transitory computer-readable medium containing program instructions, which, when executed by at least one processor of at least one computer, cause the at least one processor to:
send a search query to a search engine associated with a server system in data communication with a client system having a search engine interface;
receive, from the search engine, a set of returned pay-per-click search results that match the search query, the set of returned pay-per-click search results generated by the search engine in response to the query;
receive, from the search engine, a set of returned cost-per-impression search results that match the search query, the set of returned cost-per-impression search results generated by the search engine in response to the query; and
display or cause the display, at or within the client system, of at least a portion of the returned pay-per-click search results, and at least a portion of the returned cost-per-impression search results, in a single web browser window.

### BRIEF DESCRIPTION OF THE DRAWINGS

Reference will now be made, by way of example only, to the figures which illustrate the preferred embodiment of the invention, and in which:

FIG. 1 is a block diagram of an embodiment of a system according to the present invention;

FIG. 2 is an example search engine results page according to the present invention;

FIG. 3 is a flow chart showing steps of an embodiment of the method according to the present invention;

FIG. 4 is a flow chart showing the qualification of different types of paid advertising items in accordance with an embodiment of the invention;

FIG. 5 is a flow chart of steps for calculating the value of a CPI display item, according to the present invention; and

FIG. 6 is a flowchart showing an example method for generating score data to rank CPI items.

### DESCRIPTION OF THE INVENTION

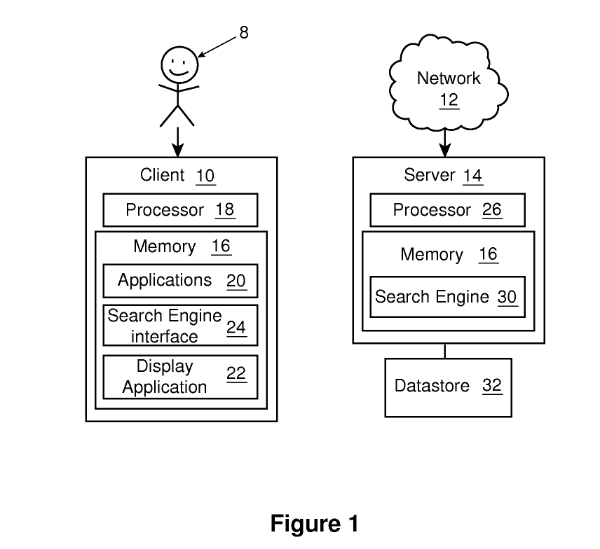

FIG. 1 is a block diagram showing an example of the system environment in which one or more embodiments of the invention may operate. FIG. 1 shows a client device 10, connected via a network 12 to a server device 14. It will be appreciated that typically, communications between multiple client devices 10, and server 14, could occur via network 12. The network 12 in the embodiment of FIG. 1 comprises the internet, but may, less typically, in other embodiments, comprise other networks, e.g. an intranet. Furthermore, in some embodiments of the present invention, the methods described in this specification may operate within a single device. Network 12 may be a wired and/or wireless network.

Each client device 10 comprises a computer readable medium, preferably in the form of Random Access Memory (RAM) 16, coupled to processor 18. The processor 18 is configured to execute computer-executable program instructions stored e.g. in memory 16. Processor 18 may be one or more processors, including one or more microprocessors, or ASICs, or other processors, or any combination thereof. The processor 18 may itself include, or may be associated with, computer-readable media storing instructions that cause the processor 18 to perform the steps described in this specification, when the instructions are executed by the processor 18. These computer-readable media may be, or may include, memory 16.

Computer readable media may include, for example, an ASIC, RAM, ROM, a memory chip, magnetic media, DVD, CD ROM, floppy disk, optical media, electronic media or other computer-readable media.

Client device 10 may be a personal computer, a digital assistant, a cellular phone, a mobile phone, a smart phone, a pager, a digital tablet (e.g. iPad®), a laptop computer, an internet device, a television (such as internet-enabled television) or other processor-based computing device. Stored within example memory 16 and operating on client 10 are client applications 20 and a display application 22. A display application 22 may be for example, a web browser (e.g. Internet Explorer®), or other application that may be used to display internet or other network search results. Applications 20 may also include web browsers, and can further include other document display applications such as word processors, email programs, spreadsheet programs, image display programs and other applications for working with or displaying documents of various types.

The client 10 preferably further comprises search engine interface 24. Search engine interface 24 comprises a client interface for the search engine on server 14, described below. Using search engine interface 24, the user 8 of client 10 can enter a search query, which search query is transmitted to server 14 and received by server 14.

It will be appreciated that search engine interface 24 may make use of display application 22. For example, display application 22, which may be a web browser, may comprise known web browsers such as Internet Explorer® or FireFox®. A client seeking to do a search, for example, using the Google® search engine, may visit the corresponding website using display application 22. The website presents a search engine interface at which user 8 at client 10 can enter a search query to be transmitted by a network 12 (in this example, the internet) to server 14.

Server 14 preferably comprises server processor 26 coupled to computer-readable memory 28. In FIG. 1, server 14 is shown for convenience as a single computer system. However, it may in some embodiments be implemented as a network of computers and/or computer processors, or alternatively, one or a network of other processor-based devices.

In the embodiment of FIG. 1, memory 28 contains the search engine application program 30. Search engine 30 comprises technology to locate relevant information in response to a search query that is received at server 14 from client 10. In the preferred embodiment, the server 14 includes, on memory 28, an index. Typically, in relation to the internet, the index is created by the performance of a crawl of the internet to locate web pages, documents and the like for indexing. The index may also be located on a separate data storage device apart from memory 28. Typically, the index is updated from time to time by continuous or intermittent crawling.

The methods according to the present invention may be implemented by processor-executable program code stored on a computer-readable medium (which may comprise, for example, a processor-based device, an ASIC, RAM, ROM, a memory chip, magnetic media, DVD, CD ROM, floppy disk, optical media, electronic media or other computer-readable medium, or any feasible combination thereof). In one embodiment, a search query is entered into search engine interface 24, and then transmitted by client 10 via network 12 to server 14. Search engine 30 receives the query and executes a search against the index to locate relevant search results. Such search results, as when performed on known search engine technologies such as Google®, Bing®, and Yahoo!®, are typically referred to as organic or natural search results.

Datastore 32 is preferably associated with server 14. It will be appreciated that data store 32 may be implemented as one or more computer readable media (which may comprise at least one processor-based device, ASIC, RAM, ROM, a memory chip, magnetic media, DVD, CD ROM, floppy disk, optical media, electronic media or other computer-readable medium, or any feasible combination thereof). Datastore 32 may be used to store databases or indices referred to in this specification, and in particular, those accessed or used by server 14.

Although FIG. 1 shows processor 18 and memory 16 within a single client computer 10, processor 18 and memory 16 may be distributed in different locations, machines or devices. Furthermore, each of processor 18 and memory 16 may comprise multiple processors or memory units respectively, such multiple elements being positioned together with or apart from one another. Similarly, processor 26 and memory 28 are shown within a single server device, but may similarly be disposed in different locations, machines or devices, and may comprise multiple elements that are positioned together with or apart from one another.

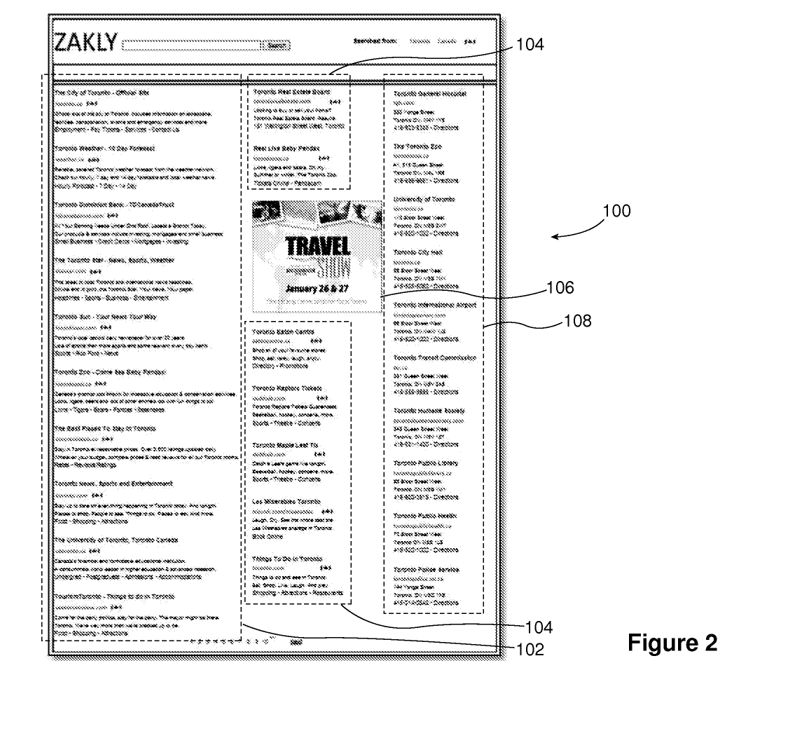

FIG. 2 shows an example search engine results page (SERP) in accordance with an embodiment of the present invention. In the example of FIG. 2, a user 8 has entered the search query “Toronto”. The query has been entered into search engine interface 24 of client 10, and transmitted by client 10 via network 12 to server 14, which has received the query.

Search engine 30, having received the query, executes a search by means of its search engine technology and returns search results. As can be seen at the bottom of FIG. 2, the generated search results continue onto additional pages (though this may not happen in every case). FIG. 2 shows the search results returned by search engine 30 on the first page of search results.

In the example of FIG. 2, returned organic search results 102 are shown in the left column of the SERP 100. Returned organic search results 102 preferably comprise at least a subset of the organic search results generated by the search query delivered to search engine 30. In the example of FIG. 2, the returned organic search results comprise links and text. In other embodiments, they may include other forms of search results, such as, for example, video and images. Various forms could be included in set of returned search results.

In the middle column, returned pay-per-click search results 104 are displayed. These comprise at least a subset of the set of pay-per-click display items generated by search engine 30 in response to the query entered by user 8.

Also displayed on SERP 100 are returned cost-per-impression search results 106. The returned cost-per-impression search results 106 preferably comprise at least a subset of the set of cost-per-impression display items generated by search engine 30 in response to the search query. As will be discussed below, results 106 preferably comprise a single cost-per-impression display item.

Also on SERP 100, at the right hand side in FIG. 2, there are returned local search results 108, comprising at least a subset of the set of local search results generated by search engine 30 in response to the search query. Returned local search results 108 are, in the embodiment of FIG. 2, organic search results, generated by search engine 30, that are specifically relevant to the location (known or suspected) of the user 8 or the client 10, and that match the search query. Local search results are described, for example, in U.S. Pat. No. 7,437,353.

In the example SERP 100 shown in FIG. 2, the search query entered was the word “Toronto”. Organic search results 102 are shown on the left side of the page, and comprise items found by executing search technology to search an index (referred to above) of articles internet searchable documents connected to the internet, which index is associated with the search engine 30. In some embodiments, the index may be stored in datastore 32.

Organic search results typically consist of hypertext links to indexed pages and documents. The links are typically displayed in the form of text, as shown in FIG. 2, but sometimes in the form of universal resource locators (URLs). As can be seen in FIG. 2, organic search result items are often accompanied by a short text.

The returned pay-per-click search results and returned cost-per-impression search results are shown in the middle column of the SERP 100 of FIG. 2. Both comprise sponsored search results (i.e. paid search results). Pay-per-click search results are distinguished by the manner in which the operator of search engine 30 derives revenue from the pay-per-click search results. Returned pay-per-click search results can take a number of different forms. These include URLs, hypertext links, and product image display advertisements. They may also take other forms. What distinguishes pay-per-click advertising is that the advertiser (i.e. the entity that pays the operator of search engine 30) only pays if the person to whom the pay-per-click search results are returned, clicks on the search result. “Click” refers to the use of a mouse, or touchscreen, or some other means, to select and activate the hyperlink. Typically, this involves using the mouse to select a hypertext link or other type of link to proceed to the website or other web-accessible article of the paying advertiser. Every time such a click is made, the advertiser sponsoring the relevant pay-per-click search result is charged. If a pay-per-click search result is not clicked, then there is no payment to the operator of search engine 30 by the advertiser.

By contrast, cost-per-impression (CPI) search results generate revenue for the operator of search engine 30 simply by virtue of being displayed in SERP 100, or otherwise displayed among search results. The advertiser paying for a cost-per-impression display item has agreed to pay as soon as that item is displayed. As a result, cost-per-impression search result items are typically visually larger than PPC items, and contain more information to attract the attention of the user 8. In the example SERP shown in FIG. 2, the cost-per-impression search result is an advertisement for a travel show. There are images and catchphrases in the advertisement, together with information about the date and place of the show. Such an advertisement is therefore generally more compelling to user 8 than simple hypertext links and/or URLs, even if the latter are accompanied by brief descriptive text. This might explain, at least in part, why an advertiser would be willing to pay for the display of such an advertisement in search results, without requiring that the advertisement be clicked.

For similar reasons, it is preferred that only one CPI item be displayed at once on SERP 100. It is believed that because of the nature of CPI (sometimes referred to as CPM) display items, the value of a CPI item is maximized if only a single one is displayed. If multiple CPI display items are displayed at once, it is believed that there is a risk that none will be as compelling to the user as it would be if it were displayed alone. Thus, in the preferred embodiment, only a single CPI item is displayed on SERP 100 in response to the search query.

Cost-per-impression or CPI is sometimes referred to as cost-per-thousand, or CPM. This latter nomenclature is derived from the fact that such advertising is often bid on, and its pricing expressed based on, the cost to the advertiser per thousand impressions (i.e. displays). However, CPI and CPM are essentially the same. In the SERP context, the advertiser has agreed in advance to pay the search engine operator for display of the ad. If the previously agreed price was, say, $100 per thousand displays, and the ad is displayed 553 times, then the advertiser would pay $55.30.

On the right side of SERP 100, local search results are shown. These returned local search results 108 are not paid or sponsored. Rather, they are generated by the operation of the technology of search engine 30 that may take into account both the location of the user 8 (or the client 10), and the relevance to the search query. Different existing search engines, such as Google®, Yahoo!®, and Bing®, may use different technological configurations or algorithms to produce and return local search results. At present, with these technologies, neither ordinary organic search results, nor local search results, are paid, but rather, they are generated by the ordinary operation of the algorithm within search engine 30. These algorithms have criteria for determining the relevance of local and organic search results to the search query, and if the criteria are met sufficiently, a match is made, and the particular result may be displayed in the SERP 100.

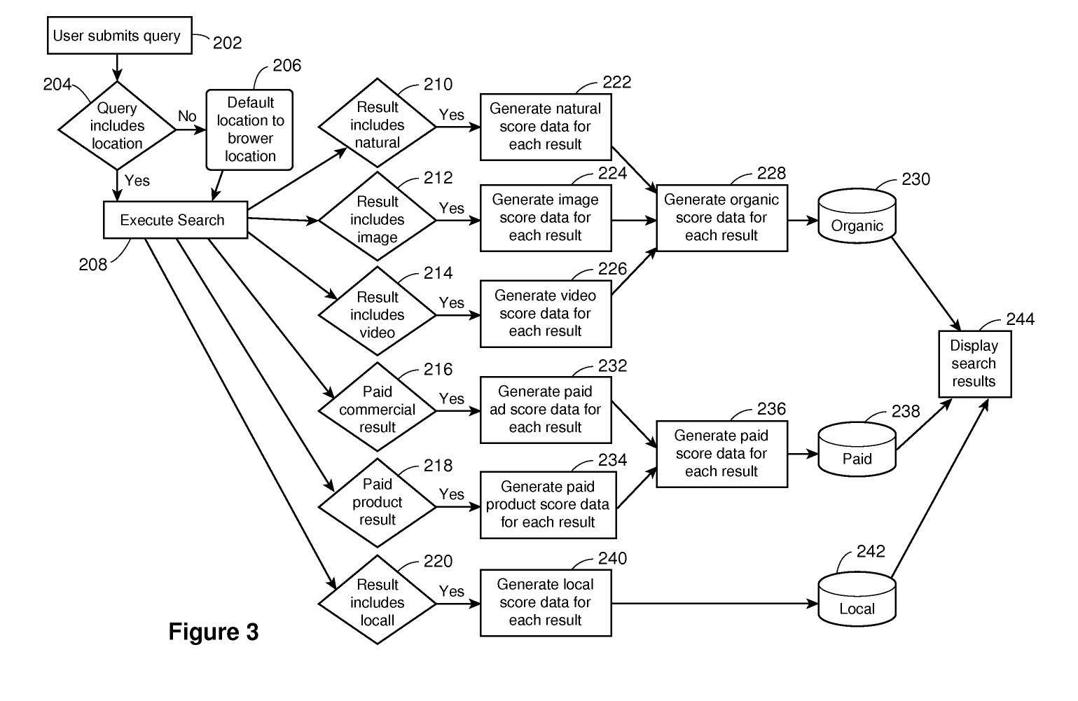

Thus, for example, the search engine technology may operate as follows. For organic search results, the search engine steps through the items in the index. For each item, the search engine determines the relevance of the item to the query, and assigns a score to the item. For each item, a decision is made as to whether to include it in the returned organic search results. If its score is below a predetermined relevance standard, the item is excluded from the returned organic search results. If its score equals or exceeds the predetermined relevance standard, it is included. The search engine technology may sort the items included in the returned organic search results so that they are displayed in descending order of relevance. The local search results may be treated similarly. It will be appreciated that a different decision process, other than this example process, may be used in particular search engine technologies. Referring now to FIG. 3, an example embodiment is shown of the steps between the submission of the search query and the display of search results. In step 202, the user 8 submits a query at search engine interface 24. At step 204, a decision is made at which the search engine 30 parses the query and determines whether the query includes explicit reference to a location, or not (step 204). For example, the query “taverns Toronto” includes explicit reference to a location; the query “taverns” does not.

If not, at step 206, the search engine 30 will default to the location of the web browser being used by user 8, typically co-located with the client 10. If yes, the search is executed using the location included in the query (step 208).

The search is then executed (step 208). The search engine 30 of this embodiment uses the search query to search a first database of PPC display items to generate a set of PPC search results that match the query. The search query is also used to search a second database of CPI display items to generate a set of CPI search results that match the search query. In addition, the search engine's index (typically an internet index of web-accessible documents, articles etc.) is searched using the search query to generate a set of organic search results that match the search query. The index is also searched using the search query to generate a set of local search results that are relevant to the location and that match the query.

As the search is executed, the search engine 30 may generate a variety of different types of search results. The search engine 30 will decide and determine whether the search results include natural search results (step 210), images (step 212) or video (step 214). “Natural” refers to the typical links/text results generated by existing search engines, and returned results 102 shown in FIG. 2 are natural search results. In the example embodiment of FIG. 3, the search results referred to at step 210, 212 and 214 are all organic in nature (i.e. not paid or sponsored).

The search engine 30 will also decide and determine whether the search results include paid search results (Step 216) or paid product results (step 218). “Paid product results” typically refers to a product image advertisement paid for on a PPC basis, while paid search results typically refers to link/text results paid for on a PPC basis. However, either may also include CPI display items, as described in this specification. In addition, the search engine 30 decides and determines whether the generated results include local search results (step 220).

It will be appreciated that other kinds of results may be returned. For example, the search engine 30 could return natural audio or paid audio.

Subsequently, natural score data (step 222), image score data (step 224) and video score data (step 226) are generated by search engine 30 for each natural, image and search video result respectively. The scores for steps 222, 224 and 226 are fed into step 228, where overall organic score data is generated for each search result. The score data generated are then moved into an organic search results database (step 230) for display (step 244).

Score data refers to a ranking score associated with each search result that reflects the priority for display to be given to the search result. Thus, in the embodiment of FIG. 3, once ranking is done for each type of organic result (natural—step 222, image—step 224, video—step 226), overall organic score data is generated to create ranking information among all of the organic results (step 228).

At step 232, search engine 30 generates score data for each paid ad search result. At step 234, the search engine 30 generates paid product image score data for each paid product result. Both of these data scores are fed to step 236, where overall paid search results score data is generated for each search result to create an overall ranking for each paid search result within the pool of paid ad/commercial and paid product results. Other paid results, if present, would also preferably form part of this pool. At step 238, at least some of the results for which a score was generated are moved into a paid search result database, and then displayed (step 244).

At step 240, local score data are generated for each local search results. The results, together with the score data, are moved to a local search result database 242 for display (step 244).

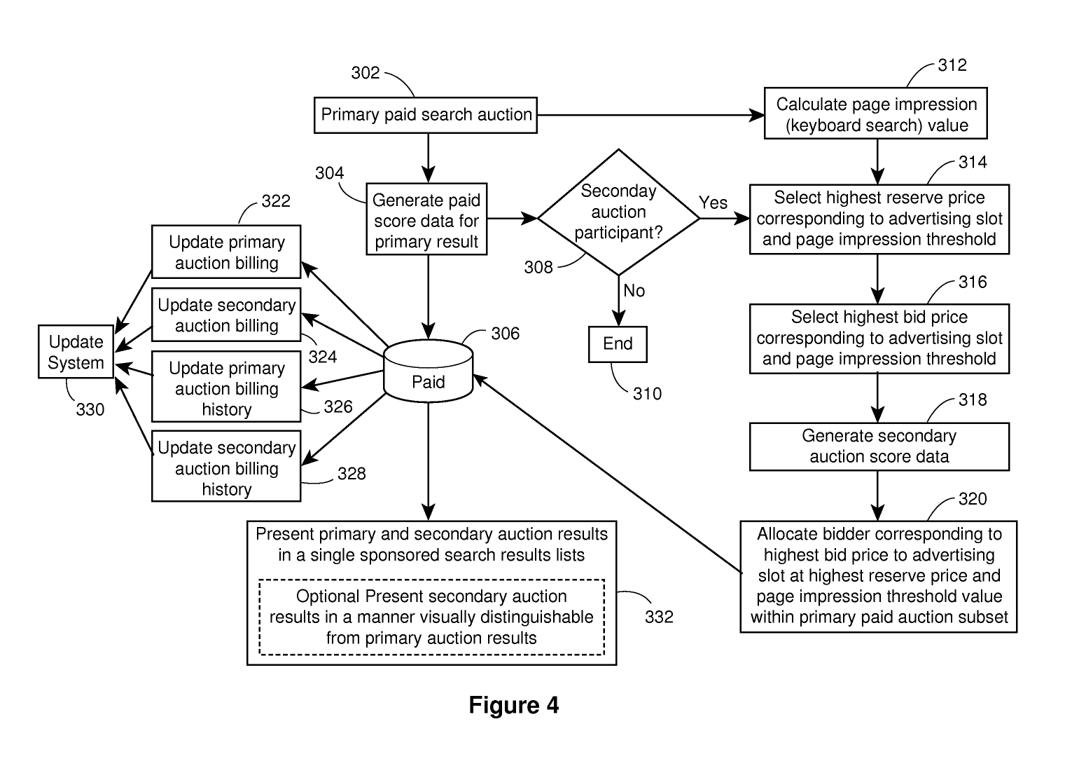

In FIG. 4, the process for qualifying an item for display by search engine 30 is shown. It will be appreciated that before search engine 30 will display a display item as a paid search result, that display item is typically qualified for display, that is, identified as an item that the search engine operator has decided it is prepared to display.

Typically, advertisers pay for display of their paid results in SERPs by agreeing to pay a particular price (e.g. 2 cents per click) to have the results displayed when particular keyword(s) is/are entered. The price is commonly determined by means of an automated auction operated by the search engine operator. Advertisers bid on keywords or groups of keywords in ways that are known in the art, such as second-price auctions. With auctions, the search engine operator typically establishes a reserve price. The reserve price is a minimum price that the search engine operator is willing to accept. If none of the bids is at least equal to the reserve price, then no paid results will be displayed for the relevant keyword or group of keywords. Fixed price arrangements, though much less common, are another method by which the price for displaying paid results is determined.

In an embodiment of the present invention, CPI display items are first qualified as PPC display items before subsequently going through the process of qualifying as CPI display items, so as to be available for display as CPI search results on the search.

Referring now to FIG. 4, a primary paid search auction takes place (step 302). This auction is the means by which the PPC price is determined for a particular PPC display item. If this item qualifies based on price and other considerations, score data are generated for the PPC item (step 304), The score data indicates the priority that would be given to the item in the event of the query having particular keywords. The item is placed in a database 306, a subset of which is a first database of PPC display items.

The system then decides and determines (step 308) whether the advertiser is participating in a secondary auction. The secondary auction is the auction to determine a price for CPI items. If not, no further action is taken regarding a secondary auction (step 310). If yes, the auction process proceeds.

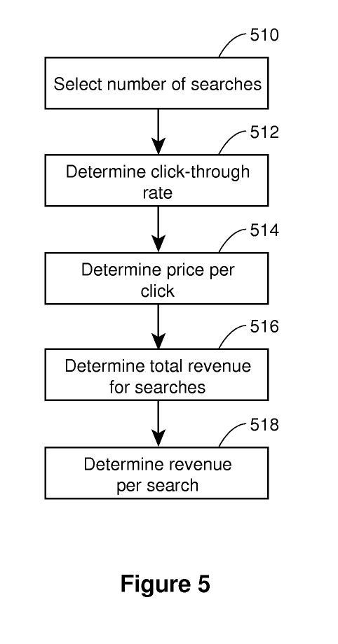

Step 312 comprises determining or calculating keyword search value as part of setting a reserve price for the secondary auction. Step 312 is elaborated more fully in FIG. 5.

FIG. 5 shows a method for calculating page impression (keyword search) value. The purpose of executing the method of FIG. 5 is to determine what minimum price would, in the preferred embodiment, be charged for a CPI search result for a particular keyword. A number of searches is selected (step 510), with those searches functioning as historical value data. Preferably, the number of searches selected will be large enough to provide a solid statistical basis for the value calculation. Also, preferably, the searches should be recent enough to provide a useful indication of current keyword search value. Suppose, for example, that the last one thousand searches will be used.

The click-through rate for these last one-thousand searches is determined (step 512), using data retained by search engine 30. Thus, when the example keyword was entered in the last thousand search queries, a paid search result was selected (generally by being clicked on) a certain percentage of the time—that percentage is the click-through rate. For this example, the click-through rate will be 2%.

The total number of clicks resulting from the selected number of searches is calculated. In this example, that would be 2% of 1000, or 20.

The average price per click for those searches is determined (step 514), again using data retained by search engine 30. In this example, the price per click is $2. Thus, the total revenue obtained in the selected number of searches can be calculated by multiplying the number of clicks resulting from selected number of searches by the price per click (step 516). In this case, the total revenue per thousand searches was $40. The average revenue per search is thus calculated (step 518). In this example, it is $0.0400.

Preferably, the minimum price, or reserve price, in the secondary auction is at least, and most preferably equal to, that average revenue per search determined from PPC results—in this example, $0.0400. The reason is that a CPI item that is displayed in a search provides the advertiser with a benefit comparable to the total revenue associated with a single SERP of PPC items. Unlike with PPC items, the value of a CPI item is not contingent on a click. An advertiser would typically pay on a CPI basis to display an ad that delivers value merely by being displayed on a SERP. Thus, CPI ads are typically display ads with substantial information and image content. The example CPI search result 106 in FIG. 2 gives substantial information about a travel show, including dates and sponsor, and includes images designed to draw the attention of a user 8.

Returning now to FIG. 4, at step 314, the reserve price is set at the page value calculated in step 312. In the embodiment of FIG. 4, an auction takes place for CPI advertising slots (step 316) and the highest bid that matches or exceeds the reserve is price selected, in a manner similar to auctions for PPC slots on SERPs. Score data is generated (step 318) for each CPI display item.

At step 320, qualified CPI display items are moved to database 306, such qualified CPI items also having qualified in the PPC auction. Thus, the qualified CPI items are a subset of the qualified PPC items. It is possible that all qualified PPC items also qualify as CPI items, though this is not typical.

Thus, it will be appreciated that CPI display items preferably only qualify for display on SERPs in accordance with the present invention if they have also qualified for display as a PPC search result. In the preferred embodiment, a CPI item must have qualified in the PPC auction before qualifying as a CPI display item.

The reason that this arrangement is preferred is as follows. Operators of search engines want as many clicks as possible for PPC items, because the greater the number of clicks, the greater the revenue from PPC items. Thus, in choosing PPC items, these operators give substantial weight to relevance (i.e. how likely a result is to be selected after a search for the particular keyword) because they are seeking the best possible performance. A CPI item that has already successfully passed through the PPC qualification process is likely to be relevant to users, and thus to command a higher price for display as a CPI item. Furthermore, the process of qualifying as a PPC item usually involves vetting by the search engine operator of the website of the other web-accessible article that a user is taken to when he/she clicks on the link. Thus, if a CPI item has previously qualified as a PPC item, such vetting will have already been done.

Qualified CPI items are placed in database 306, a subset of which is a second database of CPI display items. Thus, qualified PPC items may be said to be in a first database, and qualified CPI items in a second database, because each item is identified as either PPC or CPI, even if all of the items are on the same memory, or even in the same database file.

Once the PPC and CPI items are qualified and placed in database 306, primary and secondary auction billing systems are updated (steps 322 and 324), as are the historic data for primary and secondary auctions (steps 326 and 328). These historic data are used, inter alia, in calculating page values to set reserve prices, as described above at step 312. These updates are included in the overall update to the system of search engine 30 (step 330). The qualified PPC and CPI items are presented together on SERPs as described above (step 332).

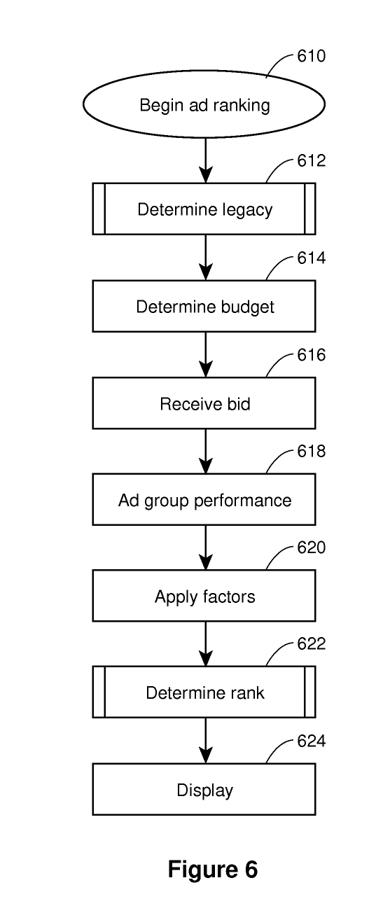

Referring now to FIG. 6, an example method is shown for generating score data (as in step 318) to rank CPI items (PPC items may be ranked by a similar process). At step 610, the ad ranking process is started. The system inquires and determines whether the campaign has any legacy (step 612), that is, whether the advertiser behind the item has already been running an advertising campaign using the relevant keyword or ad group (a group of related keywords). The existence of a legacy will preferably raise the ranking of the CPI item, at least as a tie breaker if there is otherwise a tie with another item.

Another factor considered (step 614) is the budget (e.g. a dollar amount per unit time that the advertiser is willing to pay for display in search results, such as $500 per month). If the budget is exhausted, the item will not be shown. Another factor considered is the CPI or CPM bid (step 616) i.e. how much the advertiser is willing to pay per impression or per thousand impressions. A higher bid will tend to raise the ranking of the item.

Another factor considered is ad group or keyword performance (step 618). This performance is based on data showing the click-through rates achieved by the advertiser previously in relation to the keyword or ad group. Higher rates indicate greater relevance to the keyword or ad group, and thus raise the ranking of the CPI item. Also, if performance was high as PPC, it will likely also be high as CPI.

In this embodiment, these four factors (step 620) are used to calculate score data, which determine rank (step 622). At the time of a search, whichever returned result is determined to rank highest (step 624) is displayed. In the event multiple CPI ads are to be displayed (not preferred), the highest ranking ads are displayed.

It will be appreciated that the four factors described above need not be given equal weight. In some embodiments, performance or relevance will be given the highest weight, followed by price bid, then budget, then legacy. In other embodiments, the price bid may be given the highest weight. Other weighting strategies are also comprehended.

It will be appreciated that, for example, search engine 30 may operate as follows in relation to PPC and CPI items. In response to a search query, the search engine 30 will search the first database of qualified PPC display items and the second database of qualified CPI display items. PPC and CPI items returned for possible display are then ranked by means of the generation of score data for each item. PPC items are displayed on the SERP in order of ranking. Regarding CPI items, preferably only one is displayed per SERP, and preferably it is the highest ranking one. If N CPI items are displayed, then preferably they would comprise the N highest ranking CPI items.

While the foregoing preferred embodiments of the present invention have been set forth in considerable detail for the purpose of making a complete disclosure of the invention, it will be apparent to those skilled in the art that other embodiments described herein are comprehended by the broad scope of the invention as defined in the appended claims.

1. A computer implemented method of presenting search results, the method comprising:
on a server system having a network search engine which comprises one or more processors, and memory storing one or more programs executed by the one or more processors:
receiving a search query from a client computer;
using the search query, searching a first database of pay-per-click display items to generate a set of pay-per-click search results that match the search query;
using the search query, searching a second database of cost-per-impression display items to generate a set of cost-per-impression search results that match the search query; and
sending returned pay-per-click search results, comprising at least a subset of the set of pay-per-click search results, if any, and returned cost-per-impression search results, comprising at least a subset of the set of cost-per-impression search results, if any, to the client computer.

2. A method as claimed in claim 1, wherein said sending step comprises sending to the client computer the returned pay-per-click search results and the returned cost-per-impression search results to be displayed together in a single web browser window.

3. A method as claimed in claim 1, wherein said returned cost-per-impression search results comprise a single cost-per-impression display item.

4. A method as claimed in claim 1, wherein the method further comprises, prior to said searching steps:
qualifying a plurality of PPC display items for display on a SERP, and placing said plurality of qualified PPC display items in said first database; and
qualifying a plurality of CPI display items for display on a SERP, wherein the plurality of qualified CPI display items comprises a subset of said qualified plurality of PPC display items, and placing said plurality of CPI display items in said second database.

5. A method as claimed in claim 4, wherein qualifying a plurality of CPI display items includes receiving a bid relating to each of said plurality of CPI items that matches or exceeds a predetermined reserve price.

6. A method as claimed in claim 5, wherein the method further comprises determining said reserve price by calculating a page impression value based on prior data for PPC display items, and setting the reserve price at or above the page impression value.

7. A method as claimed in claim 5, wherein the reserve price is set at the page impression value.

8. A method as claimed in claim 1, the method further comprising: using the search query, executing a search on an index to generate a set of organic search results that match the search query; and sending returned organic search results, comprising at least a subset of the set of organic search results, if any, to the client computer.

9. A method as claimed in claim 8, wherein the returned pay-per-click search results, returned cost-per-impression search results and returned organic search results are sent to the client computer to be displayed together in a single web browser window.

10. A method as claimed in claim 8, the method further comprising: determining a location associated with the client computer or a user of the client computer; using the search query, executing a search of the index to generate a set of local search results, comprising search results relevant to the location, that match the search query; and sending returned local search results, comprising at least a subset of the set of local search results, if any, to the client computer.

11. A method as claimed in claim 10, wherein the returned pay-per-click search results, returned cost-per-impression search results, returned local search results and returned organic search results are sent to the client computer to be displayed together in a single web browser window.

12. A computer implemented method of presenting search results, the method comprising:
on a client system having a search engine interface for entering search queries to a search engine associated with a server system in data communication with the client system:
sending a search query to the search engine;
receiving from the search engine a set of returned pay-per-click search results that match the search query, the set of returned pay-per-click search results generated by the search engine in response to the query;
receiving from the search engine a set of returned cost-per-impression search results that match the search query, the set of returned cost-per-impression search results generated by the search engine in response to the query; and
displaying or causing the display, at or within the client system, of at least a portion of the returned pay-per-click search results, and at least a portion of the returned cost-per-impression search results, in a single web browser window.

13. A method as claimed in claim 12, wherein said returned cost-per-impression search results comprise a single cost-per-impression display item.

14. A method as claimed in claim 12, the method further comprising receiving from the search engine a set of returned organic search results that match the search query.

15. A method as claimed in claim 14, wherein the method comprises displaying at least a portion of the returned organic search results in the single web browser window.

16. A computer-implemented method of presenting search results, the method comprising:
receiving a search query from a client computer;
using the search query, searching a first database of pay-per-click display items to generate a set of pay-per-click search results that match the search query;
using the search query, searching a second database of cost-per-impression display items to generate a set of cost-per-impression search results that match the search query; and
sending returned pay-per-click search results, comprising at least a subset of the set of pay-per-click search results, if any, and returned cost-per-impression search results, comprising at least a subset of the set of cost-per-impression search results, if any, to the client computer.

17. A system comprising at least one computer having at least one processor and at least one non-transitory computer-readable medium containing program instructions, which, when executed by the at least one processor of the at least one computer, cause the at least one processor to:
receive a search query from a client computer;
using the search query, search a first database of pay-per-click display items to generate a set of pay-per-click search results that match the search query;
using the search query, search a second database of cost-per-impression display items to generate a set of cost-per-impression search results that match the search query; and
send returned pay-per-click search results, comprising at least a subset of the set of pay-per-click search results, if any, and returned cost-per-impression search results, comprising at least a subset of the set of cost-per-impression search results, if any, to the client computer.

18. A computer program product comprising at least one non-transitory computer-readable medium containing program instructions, which, when executed by at least one processor of at least one computer, cause the at least one processor to:
receive a search query from a client computer;
using the search query, search a first database of pay-per-click display items to generate a set of pay-per-click search results that match the search query;
using the search query, search a second database of cost-per-impression display items to generate a set of cost-per-impression search results that match the search query; and
send returned pay-per-click search results, comprising at least a subset of the set of pay-per-click search results, if any, and returned cost-per-impression search results, comprising at least a subset of the set of cost-per-impression search results, if any, to the client computer.

19. A computer-implemented method of presenting search results, the method comprising:
sending a search query to a search engine associated with a server system in data communication with a client system having a search engine interface;
receiving, from the search engine, a set of returned pay-per-click search results that match the search query, the set of returned pay-per-click search results generated by the search engine in response to the query;
receiving, from the search engine, a set of returned cost-per-impression search results that match the search query, the set of returned cost-per-impression search results generated by the search engine in response to the query; and
displaying or causing the display, at or within the client system, of at least a portion of the returned pay-per-click search results, and at least a portion of the returned cost-per-impression search results, in a single web browser window.

20. A system comprising at least one computer having at least one processor and at least one non-transitory computer-readable medium containing program instructions, which, when executed by the at least one processor of the at least one computer, cause the at least one processor to:
send a search query to a search engine associated with a server system in data communication with a client system having a search engine interface;
receive, from the search engine, a set of returned pay-per-click search results that match the search query, the set of returned pay-per-click search results generated by the search engine in response to the query;
receive, from the search engine, a set of returned cost-per-impression search results that match the search query, the set of returned cost-per-impression search results generated by the search engine in response to the query; and
display or cause the display, at or within the client system, of at least a portion of the returned pay-per-click search results, and at least a portion of the returned cost-per-impression search results, in a single web browser window.

21. A computer program product comprising at least one non-transitory computer-readable medium containing program instructions, which, when executed by at least one processor of at least one computer, cause the at least one processor to:
send a search query to a search engine associated with a server system in data communication with a client system having a search engine interface;
receive, from the search engine, a set of returned pay-per-click search results that match the search query, the set of returned pay-per-click search results generated by the search engine in response to the query;
receive, from the search engine, a set of returned cost-per-impression search results that match the search query, the set of returned cost-per-impression search results generated by the search engine in response to the query; and
display or cause the display, at or within the client system, of at least a portion of the returned pay-per-click search results, and at least a portion of the returned cost-per-impression search results, in a single web browser window.
